(19) United States
(12) Patent Application Publication
(10) Pub. No.: US 2026/0319870 A1
(43) Pub. Date: Oct. 15, 2026

(54) MICROSERVICES BASED OBJECT-ORIENTED SOFTWARE SYSTEMS FOR MULTIPLE SIMULTANEOUS CLOUD VENDORS

(71) Applicant: Bank of America Corporation, Charlotte, NC (US)

(72) Inventors: Maharaj Mukherjee, Poughkeepsie, NY (US); Carl M. Benda, Charlotte, NC (US)

(21) Appl. No.: 19/175,047

(22) Filed: Apr. 10, 2025

(51) Int. Cl. G06F 9/54

(52) U.S. Cl. CPC G06F 9/548; G06F 9/541

(57) ABSTRACT

A system and method manage software applications across multiple cloud vendors using a microservices-based, object-oriented architecture. A Microservices Library stores modular microservices, documented by a Catalog. A First Large Language Model (LLM1) generates machine-readable abstractions from the Catalog, which a Generative Artificial Intelligence (Gen AI1) combines into applications. A Second Large Language Model (LLM2) creates vendor-specific API abstractions from cloud documentation. A Cloud Optimizer (Cld Opt1) selects vendors based on cost, efficiency, and availability, with a Deployment System executing the application across them. Unique features include real-time library updates, third-party integration, domain-specific adaptation, parallel execution, predictive optimization, and vendor switching. Supporting modules enhance training, planning, feedback, and distribution, enabling automated, scalable, and resilient multi-vendor deployment.

### TECHNICAL FIELD

The inventions disclosed herein pertain to systems and methods for managing and processing data across distributed computing environments, focusing on the deployment and orchestration of software components in a multi-vendor cloud infrastructure. This encompasses the design and implementation of software architectures that leverage modular, reusable units of functionality to enable seamless operation across diverse remote computing platforms. Additionally, the inventions involve the use of artificial intelligence systems to automate the abstraction and integration of these modular units, ensuring compatibility with varying interface protocols and optimizing resource allocation based on predefined criteria. The technology further relates to the generation of executable software instructions tailored to specific operational contexts, enhancing the efficiency and adaptability of distributed data processing systems.

### DESCRIPTION OF THE RELATED ART

The inventions disclosed herein address a significant challenge faced by organizations relying on distributed computing environments, particularly those utilizing multiple remote service providers. In many industries, entities operate complex software systems that depend on a variety of external platforms, each managed by different vendors. These platforms often function in isolation, creating operational silos where data and processes remain confined to a single provider's ecosystem. This separation stems from the distinct technological frameworks and operational protocols each vendor employs, which are rarely designed to interoperate with one another. As a result, organizations encounter difficulties when attempting to utilize resources across these platforms, leading to inefficiencies in how tasks are executed and resources are allocated.

This siloed structure poses a substantial obstacle to operational flexibility. When an organization commits to a specific vendor's platform, it often becomes locked into that provider's ecosystem due to the unique configurations and dependencies established over time. Switching to an alternative provider, even when more advantageous options emerge, requires significant effort to reconfigure existing systems. The process involves adapting to new protocols, reworking integrations, and ensuring continuity of operations, all of which demand substantial time and resources. Consequently, organizations remain tethered to their initial choices, unable to take advantage of improvements or alternatives offered by other vendors without incurring prohibitive transition costs.

Another layer of complexity arises from the differing access mechanisms each vendor implements. Each platform typically requires its own set of procedures for interaction, including specific sequences of commands and security measures that must be followed to initiate and sustain operations. These procedures are not standardized across vendors, meaning that an organization must maintain separate knowledge bases and technical capabilities for each platform it uses. This lack of uniformity complicates the management of software systems, as personnel must navigate a patchwork of requirements to keep operations running across multiple environments. The absence of a cohesive approach increases the likelihood of errors and delays, further hampering efficiency.

The financial implications of this fragmented landscape are considerable. Organizations often face higher operational costs due to the inability to shift workloads to more cost-effective platforms as conditions change. For example, if one vendor experiences an outage or offers less competitive pricing, the organization cannot redirect its processes to another provider without overcoming the barriers posed by incompatible systems. This rigidity prevents the realization of potential savings that could be achieved by dynamically allocating tasks to the most economical or available provider at any given time. Over time, these missed opportunities accumulate, placing a sustained burden on the organization's budget.

Beyond cost, the siloed nature of these platforms limits the scalability of software systems. As organizational needs grow—whether due to increased demand, new functionalities, or expansion into additional markets—the inability to distribute workloads across multiple vendors restricts the capacity to handle larger volumes of tasks. A system confined to a single provider may reach its limits more quickly, forcing the organization to invest in additional resources within that ecosystem rather than leveraging the collective capabilities of all available platforms. This constraint stifles growth and adaptability, as the organization cannot scale its operations in a manner that aligns with its evolving requirements.

The lack of interoperability also affects the reliability of software systems. When a vendor's platform encounters disruptions—such as downtime or degraded performance—the organization's operations tied to that provider are directly impacted. Without a mechanism to reroute tasks to an alternative platform, these disruptions can halt critical processes, leading to delays and potential losses. The dependence on a single point of failure within each silo undermines the resilience of the overall system, making it vulnerable to the operational stability of individual vendors rather than the collective strength of a multi-vendor environment.

Furthermore, the challenge of managing these disparate platforms extends to the development and maintenance of software applications. Creating a large application that operates effectively across multiple vendors requires addressing each platform's unique specifications from the outset. This task demands significant effort, as developers must account for varying capabilities, constraints, and interaction methods. The complexity increases exponentially when updates or new features are introduced, as each change must be tailored to fit the distinct environments of all vendors involved. This bespoke approach to development consumes resources and slows the deployment of new capabilities.

The absence of a unified framework for utilizing multiple vendors also hinders automation efforts. Many organizations rely on automated processes to manage routine tasks and optimize resource use, but the diversity of vendor protocols complicates the implementation of such systems. Automation tools must be customized for each platform, reducing their effectiveness and increasing the time required to establish a cohesive workflow. Without a standardized method to bridge these differences, organizations struggle to achieve the efficiency gains that automation typically promises, leaving manual intervention as a persistent necessity.

This fragmented ecosystem additionally impacts the ability to respond to dynamic conditions. In a competitive landscape, organizations must adjust quickly to shifts in demand, resource availability, or market opportunities. However, the rigidity imposed by siloed platforms prevents rapid reallocation of tasks to the most suitable provider at any given moment. This lack of agility places organizations at a disadvantage, as they cannot optimize their operations in real-time to meet changing needs. The inability to pivot effectively undermines their capacity to maintain a competitive edge.

The problems described above have persisted for years, representing a long-felt and unmet need within the realm of distributed computing. Organizations have sought a solution that enables seamless interaction across multiple remote service providers without the burdens of reconfiguration, incompatibility, and inefficiency. Despite advancements in software architectures and automation technologies, no approach has fully addressed the challenge of unifying diverse vendor ecosystems into a cohesive, adaptable system. The need for a method to break down these silos, reduce operational costs, enhance scalability, and improve reliability has remained unfulfilled, driving the demand for an innovative resolution to this enduring issue.

### SUMMARY OF THE INVENTION

The invention disclosed herein provides a comprehensive system and method for managing complex software applications across multiple cloud vendors through a microservices-based, object-oriented architecture. This approach begins with the decomposition of large, intricate applications into smaller, modular units known as microservices. These microservices represent standardized, reusable components that perform specific, minimal functions, such as sorting data, comparing values, or retrieving information from databases. By breaking applications into these discrete units, the system enables greater flexibility in how software is constructed and deployed, allowing each component to operate independently while contributing to the overall functionality of the application.

A key feature of this invention is the creation of a microservices library, which serves as a centralized repository for these modular components. This library houses a collection of microservices, each designed to execute a particular task with a well-defined interface. The library ensures that these components are readily available for use in building or modifying applications, reducing the need to develop new code from scratch for common functionalities. This repository approach streamlines the development process, making it possible to assemble applications by selecting and integrating pre-existing microservices tailored to specific needs.

Complementing the microservices library is a catalog that describes the functionality of each microservice in detail. This catalog acts as a reference guide, outlining what each microservice does, how it can be accessed, and the parameters it requires. The catalog provides a structured way to understand the capabilities of the library, enabling developers or automated systems to identify and select the appropriate microservices for a given application. By documenting the interfaces and operational details of each component, the catalog facilitates the efficient assembly of software solutions across diverse environments.

To automate the process of utilizing the catalog, the invention employs a first large language model, referred to as LLM1. This model is designed to interpret the catalog's descriptions and generate machine-understandable abstractions of the microservices. By processing the natural language or structured data within the catalog, LLM1 creates representations of each microservice's functionality and interface in a format that computers can readily utilize. This automation eliminates the need for manual interpretation, allowing the system to quickly identify and prepare microservices for integration into larger applications.

The invention further leverages the modularity of microservices to enable their deployment across multiple cloud vendors. Each microservice is designed to be vendor-agnostic at its core, meaning it can theoretically operate on any cloud platform. However, the system recognizes that each vendor imposes its own specific requirements for interaction, such as unique application programming interfaces and security protocols. To address this, the invention incorporates a mechanism to adapt microservices to the particular demands of each cloud vendor, ensuring compatibility without altering the core functionality of the microservice itself.

A significant aspect of this adaptability is the use of a second large language model, referred to as LLM2. This model focuses on understanding the vendor-specific interfaces and protocols documented by each cloud provider. By analyzing these specifications, LLM2 generates machine-understandable abstractions of the APIs required to deploy microservices on a given vendor's platform. These abstractions encapsulate the necessary commands, security measures, and handshake sequences, enabling seamless interaction between the microservices and the cloud environment they are deployed in. This automation ensures that the system can dynamically adjust to the operational context of any supported vendor.

The invention also introduces a generative artificial intelligence component, referred to as Gen AI1, to orchestrate the assembly of microservices into complete applications. This component takes the abstracted microservices produced by LLM1 and combines them according to the objectives of the application being built. The output of Gen AI1 is object-oriented code, where each microservice corresponds to an object with its own defined interface. This object-oriented structure organizes the code into manageable, modular units, making it easier to maintain, update, and scale the resulting application while preserving the integrity of individual components.

The preference for object-oriented programming in this system is a deliberate design choice. By mapping microservices to objects, the invention aligns the modular nature of microservices with a programming paradigm that emphasizes encapsulation and abstraction. Each object encapsulates a microservice's functionality and exposes it through a standardized interface, mirroring the API-based interaction model of the microservices themselves. This alignment enhances the system's ability to integrate and manage complex applications, as the object-oriented structure provides a clear framework for connecting disparate components.

To optimize the deployment of these applications across multiple cloud vendors, the invention includes a cloud optimizer, referred to as Cld Opt1. This component evaluates various criteria, such as cost, efficiency, and availability, to determine the most suitable vendor for executing each microservice at a given time. The optimizer operates dynamically, taking into account real-time feedback and constraints to make informed decisions. For instance, it might select one vendor over another based on lower operational costs or better resource availability, ensuring that the system maximizes its performance and resource utilization.

The cloud optimizer can be implemented using different approaches, depending on the specific needs of the system. One method involves a rule-based expert system, where predefined rules dictate vendor selection based on straightforward preferences or conditions. Alternatively, a statistical machine learning approach can be employed, allowing the optimizer to adapt and refine its decisions over time based on historical performance data. A hybrid approach combining these methods is also possible, offering a balance of deterministic control and adaptive learning to suit varying operational contexts.

The integration of these components—LLM1, LLM2, Gen AI1, and Cld Opt1—creates a cohesive workflow for managing applications across multiple cloud vendors. The process begins with LLM1 abstracting microservices from the catalog, followed by Gen AI1 stitching these microservices into object-oriented applications. LLM2 then adapts these applications to the specific requirements of a chosen vendor, as determined by Cld Opt1. This end-to-end automation eliminates manual intervention, enabling the system to rapidly construct and deploy software solutions tailored to dynamic conditions.

The invention builds on existing foundation models to enhance its artificial intelligence components. These foundation models, which may include pre-trained systems capable of generating executable code in languages like Java or Python, are adapted to the specific tasks of the system. Additional data, such as computer architectures expressed in unified modeling language or other descriptive formats, is incorporated to refine the models'understanding of software requirements. This adaptation ensures that LLM1, LLM2, and Gen AI1 are equipped to handle the specialized demands of microservice abstraction and application assembly.

A unique feature of the invention is its ability to switch microservices between cloud vendors seamlessly. Because the system abstracts both the microservices and the vendor-specific interfaces, it can reconfigure an application's deployment without altering its underlying structure. For example, if one vendor becomes unavailable, the cloud optimizer can redirect the affected microservices to another vendor, with LLM2 providing the necessary interface adaptations. This flexibility allows the system to maintain continuity of operations across diverse platforms.

The use of machine-understandable abstractions is a cornerstone of this invention. By converting catalog descriptions and vendor protocols into formats that computers can process directly, the system ensures that all interactions are automated and precise. These abstractions serve as a bridge between human-readable documentation and machine-executable instructions, enabling the artificial intelligence components to operate without ambiguity. This approach enhances the system's reliability and scalability, as it can handle an increasing number of microservices and vendors without requiring manual adjustments.

The invention also supports the execution of large-scale applications, such as those used for processing payments, approving loans, or monitoring transactions. These applications, which often involve numerous inputs and complex workflows, benefit from the modular design enabled by microservices. The system can break down such applications into manageable components, assemble them into object-oriented code, and deploy them across multiple vendors as needed. This capability ensures that even the most demanding software solutions can be managed efficiently.

Another innovative aspect is the dynamic optimization provided by the cloud optimizer. Unlike static systems that lock applications into a single vendor, this invention continuously assesses the operational landscape to make real-time deployment decisions. The optimizer's ability to balance cost, efficiency, and other factors ensures that the system remains responsive to changing conditions, such as fluctuations in vendor pricing or performance. This adaptability sets the invention apart from traditional approaches to multi-vendor management.

The system's reliance on generative artificial intelligence extends to the creation of execution plans. Gen AI1 not only assembles microservices into applications but also generates detailed plans for how these applications should run. These plans specify the sequence of operations and the dependencies between microservices, ensuring that the application executes as intended across distributed environments. This level of automation enhances the system's ability to handle complex, multi-step processes without human oversight.

The invention also anticipates future scalability by designing its components to evolve with technological advancements. The use of foundation models allows the system to incorporate new artificial intelligence techniques as they emerge, while the modular nature of microservices supports the addition of new functionalities over time. The cloud optimizer can similarly adapt to include new vendors or optimization criteria, ensuring that the system remains relevant as the landscape of cloud computing evolves.

The combination of these elements results in a robust, automated system for managing software across multiple cloud vendors. By integrating microservices, artificial intelligence, and dynamic optimization, the invention provides a comprehensive solution for constructing, deploying, and maintaining applications in a distributed computing environment. Its emphasis on modularity, abstraction, and adaptability ensures that it can meet the needs of organizations operating in complex, multi-vendor ecosystems.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most critical or essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize the inventions without undue experimentation, while also indicating the preferred method envisioned for carrying out the inventions.

In some arrangements, a method for managing software applications across multiple cloud vendors creates a collection of microservices using a microservices library, with each microservice configured to perform a specific function. A catalog generates a description of functionality and an application programming interface (API) specification for each microservice in the collection. A first large language model (LLM1) processes the description of functionality and the API specification from the catalog to produce a machine-readable abstraction for each microservice.

In some arrangements, a generative artificial intelligence (Gen AI1) combines the machine-readable abstractions into an application structured as object-oriented code, wherein each microservice corresponds to an object with a defined interface. A second large language model (LLM2) analyzes documentation from a plurality of cloud vendors to generate a vendor-specific machine-readable API abstraction for each cloud vendor. A cloud optimizer (Cld Opt1) optimizes deployment of the application by selecting a cloud vendor from the plurality of cloud vendors for each microservice based on predefined criteria including cost and efficiency, and a deployment system executes the application across the selected cloud vendors using the vendor-specific machine-readable API abstractions.

In some arrangements, the method further includes training the first large language model (LLM1) using a training module that employs a foundation model adapted with computer-executable source code and architectural descriptions to enhance interpretation of the catalog. A microservices library creates a collection of microservices, each configured to perform a specific function, while a catalog generates a description of functionality and an API specification for each microservice. A first large language model (LLM1) processes this information to produce machine-readable abstractions, which a generative artificial intelligence (Gen AI1) combines into an application structured as object-oriented code, with each microservice corresponding to an object with a defined interface.

In some arrangements, a second large language model (LLM2) analyzes cloud vendor documentation to generate vendor-specific machine-readable API abstractions. A cloud optimizer (Cld Opt1) selects cloud vendors for each microservice based on cost and efficiency criteria, and a deployment system executes the application across these vendors using the abstractions.

In some arrangements, the method adapts the generative artificial intelligence (Gen AI1) using an adaptation module to incorporate domain-specific objectives into the object-oriented code based on application requirements. This builds on a foundation where a microservices library creates a collection of microservices, a catalog generates their descriptions and API specifications, and a first large language model (LLM1), trained with a foundation model, processes these into machine-readable abstractions.

In some arrangements, the generative artificial intelligence (Gen AI1) then forms an application as object-oriented code. A second large language model (LLM2) generates vendor-specific API abstractions from cloud vendor documentation, a cloud optimizer (Cld Opt1) selects vendors based on cost and efficiency, and a deployment system executes the application accordingly.

In some arrangements, an update module updates the microservices library in real-time with new microservices detected from external sources to expand the collection. This occurs alongside the creation of microservices by the library, generation of descriptions and API specifications by the catalog, and processing by a trained first large language model (LLM1) into abstractions, which a generative artificial intelligence (Gen AI1) adapted for domain-specific objectives combines into an application.

In some arrangements, a second large language model (LLM2) produces vendor-specific API abstractions, a cloud optimizer (Cld Opt1) optimizes vendor selection, and a deployment system executes the application across the selected vendors.

In some arrangements, the cloud optimizer (Cld Opt1) evaluates vendor availability as an additional criterion to dynamically adjust vendor selection during execution. A microservices library, updated in real-time, creates a collection of microservices, a catalog generates their specifications, and a trained first large language model (LLM1) produces abstractions, which a generative artificial intelligence (Gen AI1) combines into an application tailored to domain-specific objectives.

In some arrangements, a second large language model (LLM2) generates vendor-specific abstractions, and a deployment system executes the application across vendors selected by the cloud optimizer based on cost, efficiency, and availability.

In some arrangements, the generative artificial intelligence (Gen AI1) generates an execution plan specifying a sequence of operations for the objects within the application. This follows the creation of microservices by an updated library, generation of specifications by a catalog, and processing by a trained first large language model (LLM1) into abstractions, combined into an application by a generative artificial intelligence (Gen AI1) adapted for specific objectives.

In some arrangements, a second large language model (LLM2) produces vendor-specific abstractions, and a cloud optimizer (Cld Opt1) selects vendors based on cost, efficiency, and availability, with the deployment system executing the application.

In some arrangements, a feedback module monitors performance results of the executed application to refine the predefined criteria used by the cloud optimizer (Cld Opt1). A microservices library, updated in real-time, creates microservices, a catalog generates specifications, and a trained first large language model (LLM1) produces abstractions, which a generative artificial intelligence (Gen AI1) combines into an application with an execution plan.

In some arrangements, a second large language model (LLM2) generates vendor-specific abstractions, and a cloud optimizer (Cld Opt1) selects vendors based on refined criteria, with the deployment system executing the application.

In some arrangements, the deployment system switches a microservice from a first cloud vendor to a second cloud vendor using a corresponding vendor-specific machine-readable API abstraction when the first vendor fails to meet performance thresholds. This occurs after a microservices library creates a collection, updated in real-time, a catalog generates specifications, and a trained first large language model (LLM1) produces abstractions combined by a generative artificial intelligence (Gen AI1) into an application with an execution plan.

In some arrangements, a second large language model (LLM2) generates vendor-specific abstractions, a cloud optimizer (Cld Opt1) selects vendors based on monitored criteria, and the deployment system executes and switches vendors as needed.

In some arrangements, the microservices library integrates third-party microservices into the collection by processing their specifications through the first large language model (LLM1). A real-time updated library creates microservices, a catalog generates specifications, and a trained first large language model (LLM1) produces abstractions, which a generative artificial intelligence (Gen AI1) combines into an application with an execution plan.

In some arrangements, a second large language model (LLM2) generates vendor-specific abstractions, a cloud optimizer (Cld Opt1) selects vendors with refined criteria, and a deployment system executes and switches vendors based on performance.

In some arrangements, the deployment system parallelizes execution of independent microservices across different cloud vendors to enhance application performance. A microservices library, integrating third-party services, creates a collection, a catalog generates specifications, and a trained first large language model (LLM1) produces abstractions, combined by a generative artificial intelligence (Gen AI1) into an application with an execution plan.

In some arrangements, a second large language model (LLM2) generates vendor-specific abstractions, a cloud optimizer (Cld Opt1) selects vendors, and the deployment system executes with parallelization and switching capabilities.

In some arrangements, a method for managing software applications across multiple cloud vendors creates a collection of microservices using a microservices library, each performing a specific function, generates descriptions and API specifications via a catalog, and processes these with a trained first large language model (LLM1) into abstractions. A generative artificial intelligence (Gen AI1) combines these into an application with an execution plan, adapted for domain-specific objectives, while a second large language model (LLM2) generates vendor-specific API abstractions.

In some arrangements, a cloud optimizer (Cld Opt1) selects vendors based on cost, efficiency, availability, and refined criteria, and a deployment system executes the application, switching vendors and parallelizing execution. The library integrates third-party microservices, updates in real-time, and a configuration module configures the optimizer for predictive adjustments, with a distribution module decentralizing the library across nodes.

In some arrangements, a system for managing software applications across multiple cloud vendors comprises a microservices library configured to store a collection of microservices, each performing a specific function, and a catalog configured to generate descriptions and API specifications. A first large language model (LLM1) processes these into machine-readable abstractions, and a generative artificial intelligence (Gen AI1) combines them into an application structured as object-oriented code.

In some arrangements, a second large language model (LLM2) analyzes vendor documentation to generate vendor-specific API abstractions, a cloud optimizer (Cld Opt1) selects vendors based on cost and efficiency, and a deployment system executes the application using these abstractions.

In some arrangements, the system includes a training module training the first large language model (LLM1) with a foundation model to enhance catalog interpretation, while a microservices library stores microservices, a catalog generates specifications, and a trained first large language model (LLM1) produces abstractions. A generative artificial intelligence (Gen AI1) forms an application, a second large language model (LLM2) generates vendor-specific abstractions, a cloud optimizer (Cld Opt1) selects vendors, and a deployment system executes the application.

In some arrangements, an adaptation module adapts the generative artificial intelligence (Gen AI1) for domain-specific objectives, building on a microservices library, a catalog, a trained first large language model (LLM1), and a second large language model (LLM2). A cloud optimizer (Cld Opt1) selects vendors, and a deployment system executes the application.

In some arrangements, an update module updates the microservices library in real-time with new microservices, alongside a catalog, a trained first large language model (LLM1), an adapted generative artificial intelligence (Gen AI1), and a second large language model (LLM2). A cloud optimizer (Cld Opt1) selects vendors, and a deployment system executes the application.

In some arrangements, an evaluation module in the cloud optimizer (Cld Opt1) evaluates vendor availability, working with an updated microservices library, a catalog, a trained first large language model (LLM1), an adapted generative artificial intelligence (Gen AI1), and a second large language model (LLM2). A deployment system executes the application across selected vendors.

In some arrangements, a planning module in the generative artificial intelligence (Gen AI1) generates an execution plan, integrated with an updated microservices library, a catalog, a trained first large language model (LLM1), a second large language model (LLM2), and a cloud optimizer (Cld Opt1) evaluating availability. A deployment system executes the application.

In some arrangements, a feedback module monitors performance to refine criteria for the cloud optimizer (Cld Opt1), alongside an updated microservices library, a catalog, a trained first large language model (LLM1), an adapted generative artificial intelligence (Gen AI1) with an execution plan, and a second large language model (LLM2). A deployment system executes the application.

In some arrangements, a switching module in the deployment system switches microservices between vendors based on performance, working with an updated microservices library, a catalog, a trained first large language model (LLM1), an adapted generative artificial intelligence (Gen AI1) with an execution plan, a second large language model (LLM2), and a cloud optimizer (Cld Opt1) with refined criteria.

In some arrangements, the system includes an integration module integrating third-party microservices via the first large language model (LLM1), a parallelization module parallelizing execution, a prediction module enabling predictive vendor selection, and a distribution module decentralizing the library. This works with an updated microservices library, a catalog, a trained first large language model (LLM1), an adapted generative artificial intelligence (Gen AI1) with an execution plan, a second large language model (LLM2), a cloud optimizer (Cld Opt1) with refined criteria, and a deployment system switching vendors.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates the interconnected components for managing software applications across multiple cloud vendors using a microservices-based approach. It depicts the flow of data and control through various modules, including artificial intelligence models, optimization systems, and deployment mechanisms, to enable seamless operation across diverse cloud environments.

FIG. 2 is an exemplary flow diagram in accordance with one or more embodiments disclosed herein that illustrates the detailed process of managing software applications across multiple cloud vendors using a microservices-based approach. It outlines the sequential steps from creating microservices to executing and optimizing their deployment, incorporating artificial intelligence and dynamic adjustments for efficiency.

FIGS. 3A-3D are an exemplary sequence diagram in accordance with one or more embodiments disclosed herein that illustrates the interactions between various system components and a cloud vendor for managing software applications across multiple cloud environments. It details the step-by-step communication flow, highlighting the roles of artificial intelligence models, optimization systems, and deployment mechanisms in orchestrating microservices.

FIGS. 4A-4B are an exemplary class diagram in accordance with one or more embodiments disclosed herein that illustrates the object-oriented structure and relationships of the components involved in managing software applications across multiple cloud vendors. It depicts a comprehensive set of classes, their attributes, methods, and interconnections, providing a blueprint for implementing the invention's microservices-based architecture.

### DETAILED DESCRIPTION

The invention disclosed herein provides a sophisticated framework for managing software applications across multiple cloud vendors through a microservices-based, object-oriented architecture. This approach fundamentally reimagines how complex applications are constructed and deployed in distributed computing environments by decomposing them into smaller, independent units known as microservices. Each microservice is designed to perform a specific, narrowly defined function, such as sorting a dataset or processing a payment transaction, allowing for a modular design that enhances flexibility and maintainability. This modularity is a cornerstone of the system, enabling individual components to be developed, updated, and scaled independently without disrupting the entire application.

Central to this framework is the Microservices Library, a repository that houses a collection of these microservices, making them readily available for use in various applications. This library acts as a foundational resource, storing microservices with their associated metadata, such as functionality descriptions and supported vendors, which could be implemented using a database system like PostgreSQL or a distributed storage solution like Apache Cassandra. By maintaining this centralized collection, the system ensures that developers or automated processes can quickly access pre-built components, reducing the need to recreate common functionalities from scratch and accelerating application development.

The Catalog complements the Microservices Library by providing detailed documentation for each microservice, including its purpose and application programming interface specifications. This component serves as a reference guide, enabling both human developers and automated systems to understand how to interact with each microservice. For instance, the Catalog might document a microservice's API endpoint, such as “/calculateInterest”, along with its input parameters, implemented as a structured JSON file generated through automated parsing of microservice code, ensuring clarity and accessibility across the system.

A pivotal aspect of the invention is its use of artificial intelligence to automate key processes, starting with the First Large Language Model (LLM1). This model interprets the Catalog's descriptions and specifications, transforming them into machine-readable abstractions that eliminate manual coding efforts. By leveraging a pre-trained language model fine-tuned with technical datasets, such as UML diagrams or Python code, LLM1 can convert a description like “sorts customer transactions by date” into a structured API call, streamlining the integration of microservices into larger applications.

These abstractions are then utilized by the Generative Artificial Intelligence (Gen AI1), which combines them into a cohesive application structured as object-oriented code. This component takes the modular abstractions and assembles them into a functional program, where each microservice becomes an object with a defined interface, such as a Java class “TransactionProcessor” with methods like “sortByDate()”. The use of object-oriented programming enhances the system's modularity and maintainability, allowing for easy updates or replacements of individual components without affecting the whole.

The invention also addresses the challenge of deploying these applications across multiple cloud vendors through the Second Large Language Model (LLM2). This model analyzes vendor-specific documentation, such as AWS SDKs or Azure API guides, to generate machine-readable API abstractions tailored to each vendor's requirements. For example, it might produce an abstraction for invoking an AWS Lambda function, complete with security protocols and handshake sequences, enabling seamless interaction with diverse cloud platforms without manual reconfiguration.

The Cloud Optimizer (Cld Opt1) plays a crucial role in this multi-vendor deployment by selecting the most suitable cloud vendor for each microservice based on predefined criteria like cost, efficiency, and availability. Implemented as a decision engine, it might use a weighted scoring algorithm to choose between Google Cloud and Azure, dynamically adjusting selections based on real-time data, such as server uptime or pricing fluctuations. This optimization ensures that the system maximizes resource utilization and performance across the distributed environment.

The Deployment System executes the optimized plan, sending microservices to their designated vendors using the vendor-specific abstractions provided by LLM2. This could involve deploying a sorting microservice to AWS via a RESTful API call while running a payment processor on Azure, orchestrated through tools like Terraform or Kubernetes. The system's ability to execute across multiple vendors simultaneously enhances its scalability and resilience, mitigating risks associated with vendor-specific outages.

Additional modules enhance the core functionality, such as the Training Module, which refines LLM1 with foundational data to improve its abstraction accuracy, potentially using a TensorFlow pipeline with financial system blueprints. The Adaptation Module tailors Gen AI1 to domain-specific needs, such as adding compliance logic for banking applications, while the Update Module keeps the Microservices Library current by integrating new microservices from external sources like GitHub, ensuring the system remains adaptable to evolving requirements.

The Evaluation Module within the Cloud Optimizer assesses vendor availability, providing real-time data to refine deployment decisions, possibly integrating with monitoring tools like Prometheus. The Planning Module in Gen AI1 generates execution plans, defining operational sequences like “retrieve data, then sort,” implemented as a dependency graph in YAML, ensuring efficient application execution. The Feedback Module monitors performance post-deployment, feeding data back to the Cloud Optimizer to adjust criteria, such as prioritizing latency after detecting slow responses, enhancing the system's responsiveness.

Unique features include the Switching Module, which dynamically reassigns microservices between vendors if performance thresholds are unmet, such as rerouting from AWS to Google Cloud via a failover script, and the Integration Module, which incorporates third-party microservices into the library, processed through LLM1 for compatibility. The Parallelization Module enables concurrent execution across vendors, like running sorting and logging simultaneously using a task queue like RabbitMQ, boosting performance for complex applications.

The Prediction Module introduces a predictive capability to the Cloud Optimizer, forecasting optimal vendor choices based on historical data, potentially using a model like ARIMA to anticipate peak loads. The Distribution Module decentralizes the Microservices Library across multiple nodes, such as Kubernetes clusters synchronized with Raft, improving fault tolerance and scalability. The Cloud Vendor class represents external platforms, providing execution capabilities and documentation, completing the ecosystem with real-world applicability.

This architecture's strength lies in its automation, eliminating manual intervention through AI-driven abstraction and assembly, and its flexibility, allowing deployment across diverse vendors with dynamic optimization. It supports large-scale applications, such as financial transaction systems or logistics trackers, by breaking them into manageable microservices, assembling them efficiently, and deploying them optimally. The object-oriented approach ensures maintainability, while the multi-vendor strategy enhances resilience and cost-effectiveness, making it a robust solution for modern distributed computing challenges.

Various example embodiments in the disclosure are designed to fulfill the objectives previously mentioned, drawing on the illustrations provided within this disclosure. These illustrations showcase a variety of systems and methods for putting the disclosed concepts into practice. It is understood that different approaches to implementation are feasible, and adjustments to both the structure and operation of these systems and methods are permissible. Thus, the description elaborates on numerous connections among components, which should be understood in a flexible sense. Unless specifically noted otherwise, such connections may be direct or indirect and can be facilitated through either wired or wireless means. This document is not intended to limit the form or type of these connections.

Several types of artificial intelligence are applicable to implementing aspects of the invention, each tailored to specific functions within the system. First, large language models (LLMs) are employed for the First Large Language Model (LLM1) and Second Large Language Model (LLM2). LLMs are a subset of natural language processing AI, trained on vast text corpora to understand and generate human-like language, capable of interpreting complex documentation and producing structured outputs. For LLM1, this applies to processing the Catalog's descriptions into machine-readable abstractions, where it parses technical text into API calls, such as converting “sorts transactions” into a JSON function definition, implemented with models like BERT or GPT-3 fine-tuned on software documentation. For LLM2, it generates vendor-specific API abstractions from cloud vendor docs, transforming AWS SDK text into executable calls, leveraging its contextual understanding to handle varied formats.

Second, generative artificial intelligence is used for the Generative Artificial Intelligence (Gen AI1). This type of AI focuses on creating new content, such as code or designs, based on learned patterns, distinct from merely interpreting data. It applies to combining microservice abstractions into object-oriented applications, where it generates a Java class like “TransactionProcessor” from abstracted components, using models like Codex or GPT-4 adapted with domain-specific code samples to ensure functional coherence and compliance with objectives like financial regulations.

Third, rule-based expert systems are applicable to the Cloud Optimizer (Cld Opt1) as an alternative optimization approach. These systems use predefined rules to make decisions, mimicking human expertise without learning from data. In the Cloud Optimizer, this could involve rules like “if cost<$0.03 and uptime>99%, select vendor,” implemented in a language like Prolog, offering a deterministic method to choose vendors when simplicity is preferred over adaptive learning, suitable for static environments.

Fourth, statistical machine learning is also applicable to the Cloud Optimizer (Cld Opt1). This AI type learns patterns from data using statistical techniques, adapting over time without explicit rules. It optimizes vendor selection by analyzing historical performance metrics, such as training a Random Forest model on cost and latency data to predict the best vendor, enhancing flexibility in dynamic cloud settings compared to rule-based systems.

Fifth, reinforcement learning can enhance the Cloud Optimizer (Cld Opt1) and Prediction Module. This AI learns optimal actions through trial and error, receiving rewards for successful outcomes. In the Cloud Optimizer, it could adjust vendor choices by rewarding low-cost, high-efficiency deployments, implemented with a Q-learning algorithm in Python, while in the Prediction Module, it forecasts vendor performance based on past execution rewards, refining proactive decisions over time.

These AI types—LLMs for abstraction, generative AI for assembly, rule-based systems for static optimization, statistical machine learning for adaptive optimization, and reinforcement learning for predictive and dynamic adjustments—collectively enable the invention's automation, flexibility, and efficiency, tailored to its unique needs across microservice management and multi-vendor deployment. Examples like BERT, GPT-4, Prolog, Random Forest, and Q-learning provide practical pathways for implementation, ensuring robust performance in real-world applications.

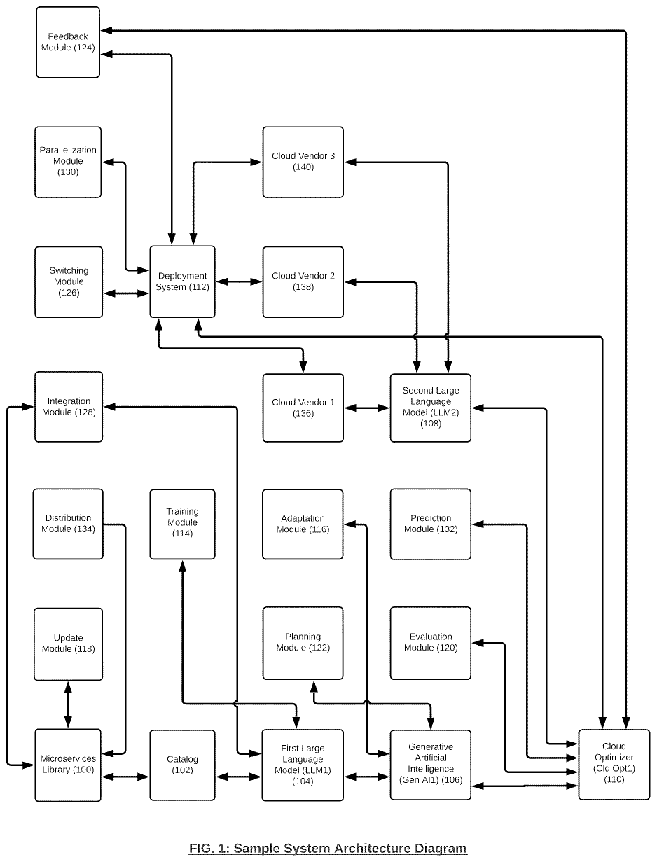

The FIG. 1 system architecture diagram begins with the Microservices Library (100), which serves as a centralized repository storing a collection of modular software components, each designed to execute a specific task. For example, this could include a sorting microservice for ordering transaction data or a data retrieval microservice for accessing customer records from a database, implemented in languages like Java or Python. Connected to this is the Catalog (102), which maintains detailed descriptions and interface specifications for each microservice in the library. An implementation might feature a JSON-based catalog listing a payment processing microservice with its API endpoints and parameters, such as “/processPayment” with inputs for amount and currency.

The Catalog (102) feeds into the First Large Language Model (LLM1) (104), a component that interprets the catalog's textual data to produce machine-readable abstractions. An example could be a pre-trained model like BERT, fine-tuned to convert a description like “sorts transaction list by date” into a structured API call format usable by downstream systems. This model connects to the Generative Artificial Intelligence (Gen AI1) (106), which assembles these abstractions into a cohesive application structured as object-oriented code. For instance, it might combine a sorting abstraction and a retrieval abstraction into a Python class called “TransactionProcessor” with methods like “sortByDate()” and “fetchRecords()”.

The Generative Artificial Intelligence (Gen AI1) (106) links to the Cloud Optimizer (Cld Opt1) (110), which determines the optimal cloud vendor for each microservice based on predefined criteria. An example implementation could be a decision engine using a weighted scoring algorithm to choose between AWS and Azure for a microservice, factoring in cost per execution and current server load. Simultaneously, the Second Large Language Model (LLM2) (108) analyzes documentation from cloud vendors to generate vendor-specific API abstractions, connecting to the Cloud Optimizer (Cld Opt1) (110). This could involve a model like GPT-3 parsing AWS API docs to create a machine-readable call like “aws.lambda.invoke” with specific authentication headers.

The Cloud Optimizer (Cld Opt1) (110) interfaces with the Deployment System (112), which executes the application across selected cloud vendors such as Cloud Vendor 1 (136), Cloud Vendor 2 (138), and Cloud Vendor 3 (140). For example, this might deploy a payment processing microservice to Google Cloud while running a data retrieval microservice on Azure, using RESTful API calls tailored to each vendor's requirements. These cloud vendors, in turn, provide documentation back to the Second Large Language Model (LLM2) (108), forming a feedback loop for continuous adaptation, such as updating API abstractions when a vendor releases a new SDK version.

Supporting the First Large Language Model (LLM1) (104) is the Training Module (114), which refines the model's capabilities using foundational data. An example could be training LLM1 with UML diagrams of banking systems and Python code snippets to improve its abstraction accuracy for financial applications. The Adaptation Module (116) connects to the Generative Artificial Intelligence (Gen AI1) (106), tailoring the application to specific domains, such as adding fraud detection logic to a transaction processing app for a financial institution.

The Update Module (118) links to the Microservices Library (100), enabling real-time additions to the collection. This might involve integrating a new encryption microservice from an external GitHub repository into the library using an automated ingestion script. The Evaluation Module (120) integrates with the Cloud Optimizer (Cld Opt1) (110), assessing additional vendor metrics like uptime, potentially using a monitoring tool like Prometheus to track AWS availability for dynamic adjustments.

Within the Generative Artificial Intelligence (Gen AI1) (106), the Planning Module (122) generates execution sequences, such as a workflow specifying that data retrieval precedes sorting in a reporting application, implemented via a dependency graph in JSON. The Feedback Module (124) connects to both the Deployment System (112) and the Cloud Optimizer (Cld Opt1) (110), refining optimization criteria based on execution outcomes, for instance, adjusting cost weights after logging slower response times on Azure.

The Switching Module (126) integrates with the Deployment System (112), enabling dynamic vendor changes, such as rerouting a microservice from AWS to Google Cloud if latency exceeds a threshold, using a failover script triggered by real-time metrics. The Integration Module (128) connects to both the Microservices Library (100) and the First Large Language Model (LLM1) (104), incorporating third-party microservices, like a publicly available logging service processed through LLM1 into a usable abstraction.

The Parallelization Module (130) works within the Deployment System (112), allowing concurrent execution across vendors, such as running a sorting microservice on AWS while a filtering microservice runs on Azure, coordinated via a task queue like RabbitMQ. The Prediction Module (132) enhances the Cloud Optimizer (Cld Opt1) (110), using historical data to forecast needs, potentially leveraging a time-series model like ARIMA to predict peak loads and preemptively shift resources.

Finally, the Distribution Module (134) connects to the Microservices Library (100), decentralizing it across multiple nodes, such as deploying library subsets on Kubernetes clusters in different regions, synchronized via a consensus protocol like Raft. This comprehensive architecture ties together a network of components, from microservice management to vendor-specific deployment, exemplified through practical implementations like cloud-based financial processing or logistics tracking systems, ensuring flexibility and efficiency across diverse operational contexts.

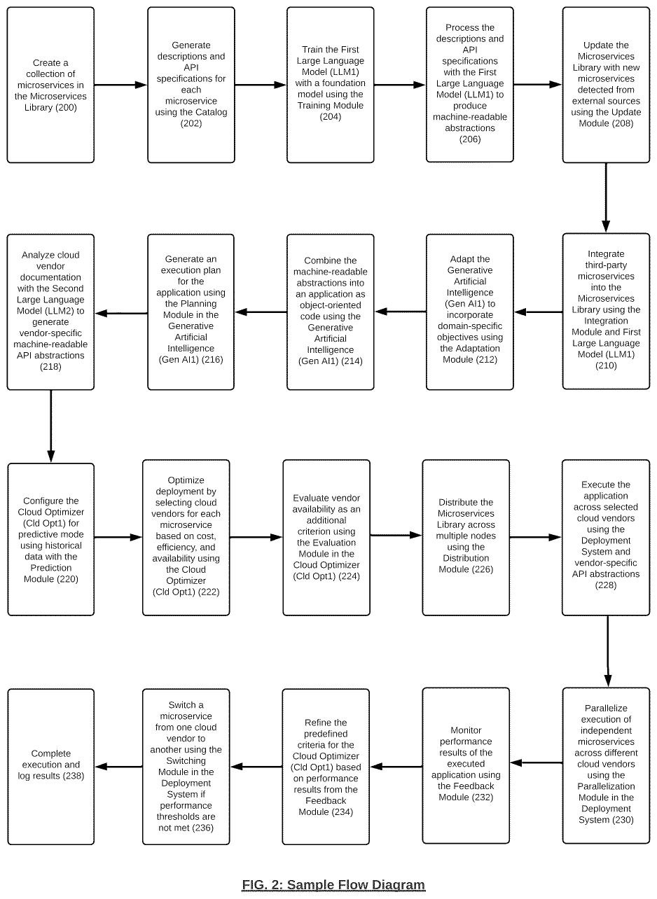

The FIG. 2 flow diagram begins with the step to create a collection of microservices in the Microservices Library (200). This involves establishing a repository where modular software components, each designed to perform a distinct task, are stored and organized for easy access. For implementation, a developer might use a database like PostgreSQL to store microservices written in Python, such as a “calculateInterest” microservice for financial computations or a “sendNotification” microservice for user alerts, with each entry tagged by its function and version. Next, the process generates descriptions and API specifications for each microservice using the Catalog (202). This step entails producing detailed documentation that outlines what each microservice does and how it can be interfaced, potentially implemented as a JSON file generated by a script that parses microservice code comments, yielding entries like {“name”: “calculateInterest”, “description”: “computes annual interest”, “api”: “/interest? principal=amount&rate=percent”}.

Following this, the flow trains the First Large Language Model (LLM1) with a foundation model using the Training Module (204). Here, a pre-existing AI model, such as a transformer-based system like BERT, is fine-tuned with datasets including UML diagrams of system architectures and Python code snippets, enhancing its ability to understand technical descriptions. This could be executed using a TensorFlow pipeline on a GPU cluster, with training data sourced from internal documentation repositories. The process then proceeds to process the descriptions and API specifications with the First Large Language Model (LLM1) to produce machine-readable abstractions (206). In this step, LLM1 interprets the Catalog's output to create structured representations, such as XML or JSON-LD, that machines can directly utilize, implemented via a Python script calling the trained model's API to transform “computes annual interest” into a callable function signature.

The next step updates the Microservices Library with new microservices detected from external sources using the Update Module (208). This involves scanning repositories like GitHub for relevant microservices, downloading them, and integrating them into the library, perhaps using a cron job that triggers a REST API to fetch a new “encryptData” microservice nightly. Subsequently, the flow integrates third-party microservices into the Microservices Library using the Integration Module and First Large Language Model (LLM1) (210). Here, external microservices, such as a logging service from a vendor, are processed by LLM1 to ensure compatibility, with an implementation involving a middleware layer that pipes third-party specs through the model and stores the resulting abstractions in the library's database.

The process then adapts the Generative Artificial Intelligence (Gen AI1) to incorporate domain-specific objectives using the Adaptation Module (212). This step customizes Gen AI1, potentially a model like GPT-4, to align with specific needs, such as adding banking compliance rules to a transaction app, achieved by feeding it domain ontologies and sample code via a retraining script. Following this, the flow combines the machine-readable abstractions into an application as object-oriented code using the Generative Artificial Intelligence (Gen AI1) (214). Gen AI1 assembles the abstractions into a cohesive program, such as a Java class “LoanProcessor” with methods derived from microservices, implemented through a code generation tool that maps abstractions to object definitions.

Next, the process generates an execution plan for the application using the Planning Module in the Generative Artificial Intelligence (Gen AI1) (216). This involves creating a sequence of operations, like “retrieve data, then calculate interest,” stored as a YAML file, generated by analyzing dependencies among microservices with a graph traversal algorithm. The flow then analyzes cloud vendor documentation with the Second Large Language Model (LLM2) to generate vendor-specific machine-readable API abstractions (218). LLM2, perhaps another transformer model, processes vendor PDFs or Swagger files to produce API calls like “aws.s3.put_object”, implemented via a document ingestion pipeline that outputs structured JSON for each vendor.

The process configures the Cloud Optimizer (Cld Opt1) for predictive mode using historical data with the Prediction Module (220). This step sets up Cld Opt1 to forecast optimal vendor choices, using a machine learning model like XGBoost trained on past execution logs to predict AWS downtime, integrated via a Python scheduler. Next, the flow optimizes deployment by selecting cloud vendors for each microservice based on cost, efficiency, and availability using the Cloud Optimizer (Cld Opt1) (222). Cld Opt1 evaluates vendors with a scoring function, perhaps coded in Go, weighing factors like $0.02 per execution on Azure versus 99.9% uptime on AWS, selecting the best fit for each microservice.

The flow then evaluates vendor availability as an additional criterion using the Evaluation Module in the Cloud Optimizer (Cld Opt1) (224). This refines the optimization by checking real-time status, implemented with a monitoring tool like Prometheus querying vendor APIs for uptime metrics. Following this, the process distributes the Microservices Library across multiple nodes using the Distribution Module (226). The library is split across Kubernetes clusters in different regions, synchronized with a Raft consensus protocol coded in Rust, ensuring decentralized access and resilience.

Next, the flow executes the application across selected cloud vendors using the Deployment System and vendor-specific API abstractions (228). The Deployment System sends API calls to vendors like Google Cloud, implemented with a Terraform script provisioning resources and executing microservices via REST endpoints. The process then parallelizes execution of independent microservices across different cloud vendors using the Parallelization Module in the Deployment System (230). This runs tasks concurrently, such as interest calculation on AWS and notifications on Azure, managed by a RabbitMQ queue dispatching jobs across vendors.

The flow monitors performance results of the executed application using the Feedback Module (232). Performance data, like latency and error rates, is collected via a logging service like ELK Stack, analyzing execution outcomes in real-time. Next, the process refines the predefined criteria for the Cloud Optimizer (Cld Opt1) based on performance results from the Feedback Module (234). This updates the scoring weights, such as increasing emphasis on latency after slow responses, implemented by adjusting a configuration file used by Cld Opt1's algorithm.

The flow then switches a microservice from one cloud vendor to another using the Switching Module in the Deployment System if performance thresholds are not met (236). If AWS latency exceeds 500 ms, the microservice is rerouted to Google Cloud, executed via a failover script triggered by monitoring alerts. Finally, the process completes execution and logs results (238). This step finalizes the operation, storing outcomes in a MongoDB database for future analysis, with a summary report generated by a Node.js script detailing execution success and vendor performance.

This detailed flow encapsulates a comprehensive process for managing microservices across cloud vendors, leveraging automation, AI, and optimization to ensure efficient deployment. Each step builds on the previous, forming a robust workflow that can be practically implemented with modern tools and technologies, adaptable to various application domains like finance or e-commerce.

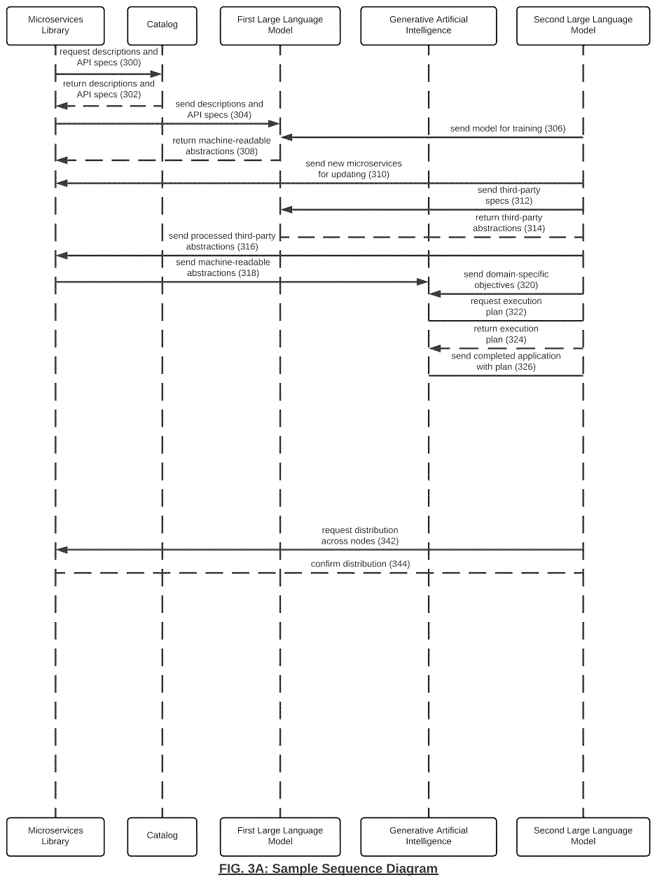

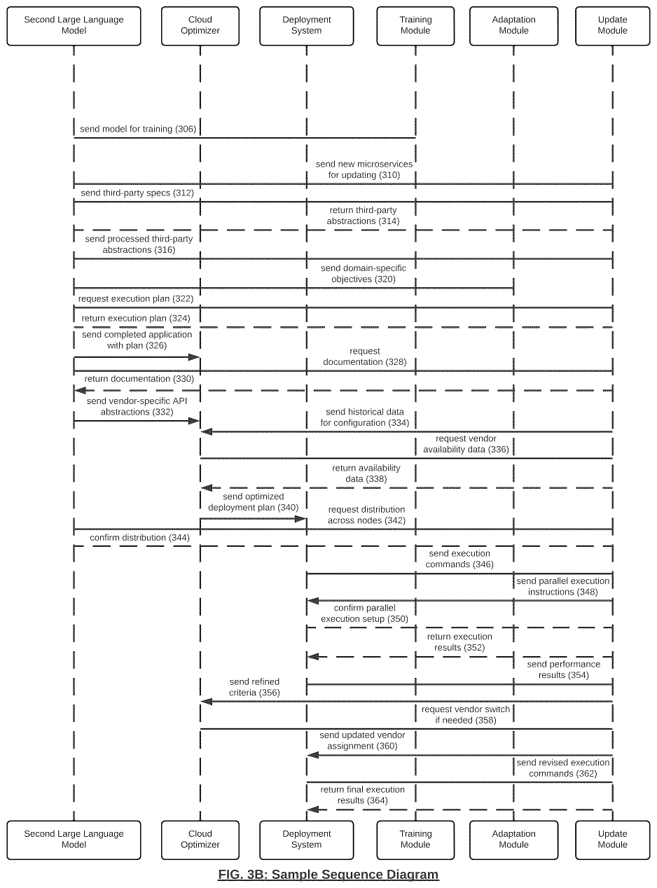

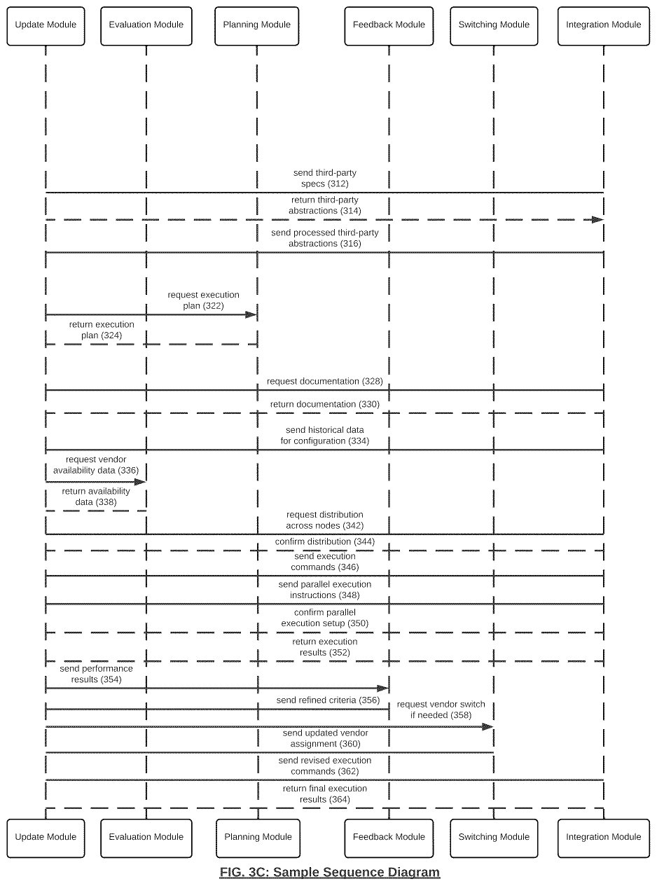

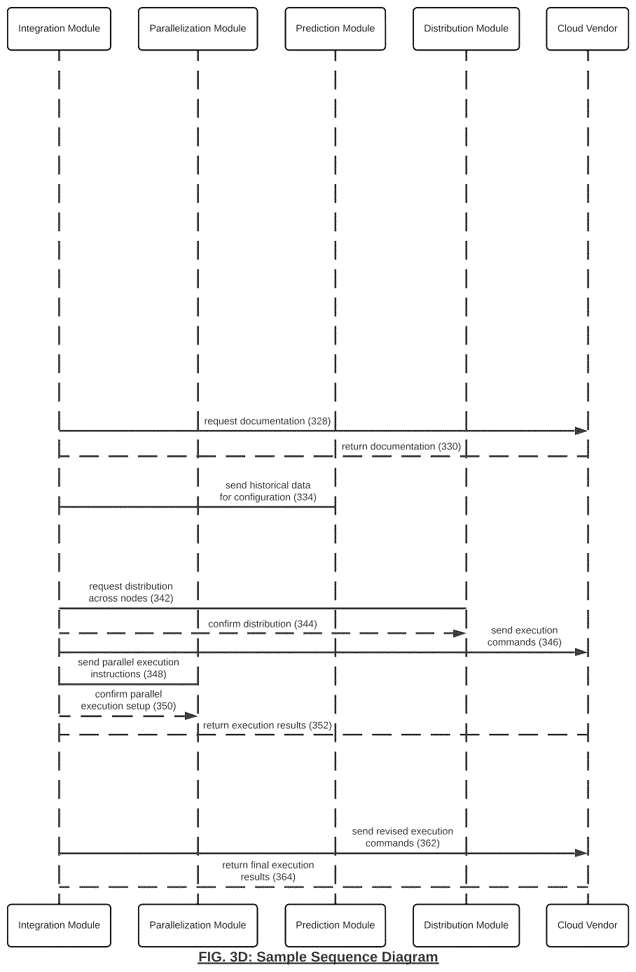

The FIG. 3A-3D sequence diagram commences with the Microservices Library sending a request to the Catalog to generate descriptions and API specifications for microservices (300). This initial interaction involves the Microservices Library, acting as a repository of modular components, querying the Catalog to produce detailed documentation for each microservice, such as a “processPayment” function with its REST endpoint and parameters. Implementation might involve a Python script within the Microservices Library making an HTTP POST request to a Catalog service hosted on a Node.js server, which responds with JSON-formatted specifications. The Catalog then returns the generated descriptions and API specifications to the Microservices Library (302). This response, potentially a JSON payload containing entries like {“name”: “processPayment”, “endpoint”: “/pay”, “params”: [“amount”, “currency”]}, is received and stored by the Microservices Library via an API callback function, ensuring the data is readily available for subsequent steps.

Next, the Microservices Library sends these descriptions and API specifications to the First Large Language Model for processing (304). This step transfers the structured data to an AI component designed to interpret technical documentation, implemented by a RESTful API call from the Microservices Library to a Flask server hosting the First Large Language Model, passing the JSON payload as a request body. The Training Module then sends a foundation model with source code and architectural data to the First Large Language Model for training (306). Here, a pre-trained model like BERT is enhanced with datasets such as Python snippets and UML diagrams, delivered via a TensorFlow training pipeline executed on a cloud GPU instance, with the Training Module pushing the updated model weights to the First Large Language Model over a secure gRPC connection.

The First Large Language Model processes this input and returns machine-readable abstractions to the Microservices Library (308). It transforms descriptions into structured formats like XML, implemented by the model running inference on a Docker container and returning results via an HTTP response to the Microservices Library's endpoint. Following this, the Update Module sends new microservices detected from external sources to the Microservices Library for updating (310). This involves scanning a GitHub repository for a new “encryptData” microservice, with the Update Module using a webhook to push the source code to the Microservices Library's ingestion API, written in Go, which updates the repository in real-time.

The Integration Module then sends third-party microservice specifications to the First Large Language Model for processing (312). This step integrates external components, such as a logging microservice, by submitting its spec sheet via a message queue like Kafka to the First Large Language Model's processing queue. The First Large Language Model returns processed third-party abstractions to the Integration Module (314). These abstractions, formatted as JSON-LD, are sent back over the same Kafka topic, with the Integration Module polling the queue to retrieve them, ensuring compatibility with the system's standards.

Subsequently, the Integration Module sends these processed third-party abstractions to the Microservices Library for inclusion (316). This finalizes their integration by submitting them via an internal REST API call, with the Microservices Library storing them in a MongoDB database. The Microservices Library then sends the machine-readable abstractions to the Generative Artificial Intelligence for combining (318). This transfer, implemented as an HTTP PUT request to a Generative Artificial Intelligence server running FastAPI, delivers abstractions like a “sortTransactions” function for assembly into a larger application.

The Adaptation Module sends domain-specific objectives to the Generative Artificial Intelligence for adaptation (320). It provides context, such as financial compliance rules, via a JSON configuration file pushed over a WebSocket connection to tailor the application output. The Generative Artificial Intelligence combines abstractions and requests an execution plan from the Planning Module (322). This involves assembling a Java class like “TransactionManager” and requesting a workflow, implemented by an internal function call within a Python-based Generative Artificial Intelligence instance to the Planning Module's planning service.

The Planning Module returns the execution plan to the Generative Artificial Intelligence (324). This plan, a YAML file detailing steps like “fetch data, then sort,” is returned via a synchronous API response, integrated into the application structure. The Generative Artificial Intelligence then sends the completed application with the execution plan to the Cloud Optimizer for deployment optimization (326). This step, executed via a gRPC call, transmits the application binary and plan to a Cloud Optimizer service running on Kubernetes, preparing it for vendor assignment.

The Second Large Language Model sends a request to the Cloud Vendor for documentation (328). It queries vendor APIs, such as AWS's SDK docs, using an HTTP GET request from a serverless Lambda function hosting the model. The Cloud Vendor returns documentation to the Second Large Language Model (330). This response, a Swagger JSON file, is received over the same HTTP channel, providing the necessary API details for abstraction.

The Second Large Language Model processes this and sends vendor-specific API abstractions to the Cloud Optimizer (332). It generates calls like “aws.lambda.invoke” in JSON format, delivered via a REST API to the Cloud Optimizer's ingestion endpoint. The Prediction Module sends historical data to the Cloud Optimizer for predictive configuration (334). This data, stored in a time-series database like InfluxDB, is pushed via a scheduled Python script to refine the Cloud Optimizer's decision-making logic.

The Cloud Optimizer requests vendor availability data from the Evaluation Module (336). It sends a query via an internal message bus like RabbitMQ to check real-time status. The Evaluation Module returns availability data to the Cloud Optimizer (338). Metrics like 99.8% uptime from Prometheus are sent back over the bus, enabling dynamic adjustments.

The Cloud Optimizer sends the optimized deployment plan to the Deployment System (340). This plan, a JSON object specifying vendors like Azure for sorting, is transmitted via a REST POST request to the Deployment System's orchestration API. The Distribution Module sends a request to the Microservices Library to distribute across multiple nodes (342). It triggers decentralization across Kubernetes clusters using a gRPC command, ensuring scalable access.

The Microservices Library confirms distribution completion to the Distribution Module (344). A success message is returned via gRPC, verifying synchronization with Raft. The Deployment System sends execution commands with vendor-specific API abstractions to the Cloud Vendor (346). It deploys microservices using Terraform scripts over HTTPS to vendors like Google Cloud, executing the plan.

The Parallelization Module sends parallel execution instructions to the Deployment System (348). It dispatches concurrent tasks via a Redis queue, such as running sorting and logging simultaneously. The Deployment System confirms parallel execution setup to the Parallelization Module (350). A confirmation message is sent back over Redis, ensuring proper setup.

The Cloud Vendor returns execution results to the Deployment System (352). Results like processed transactions are received via API callbacks, logged in real-time. The Deployment System sends performance results to the Feedback Module for monitoring (354). Metrics like latency are pushed to an ELK Stack via a REST API for analysis.

The Feedback Module analyzes and sends refined criteria to the Cloud Optimizer (356). It updates weights, such as prioritizing efficiency, via a configuration API call. The Cloud Optimizer requests a vendor switch from the Switching Module if performance thresholds are not met (358). It sends a switch command over an internal channel if AWS latency exceeds 500 ms.

The Switching Module sends the updated vendor assignment to the Deployment System (360). It reroutes to Google Cloud via a REST update, adjusting the deployment. The Deployment System sends revised execution commands to the Cloud Vendor (362). New API calls are issued over HTTPS, reflecting the switch.

Finally, the Cloud Vendor returns final execution results to the Deployment System (364). Completed outcomes are sent back via callbacks, stored in a database like PostgreSQL, concluding the sequence with a fully executed and optimized application deployment across multiple vendors, implemented through a robust interplay of APIs, queues, and AI-driven processing.

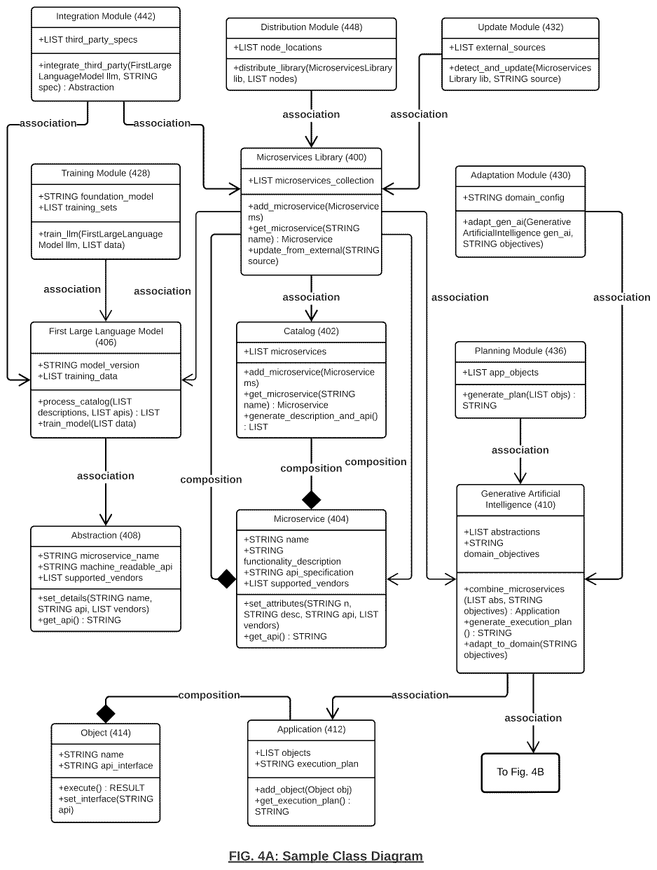

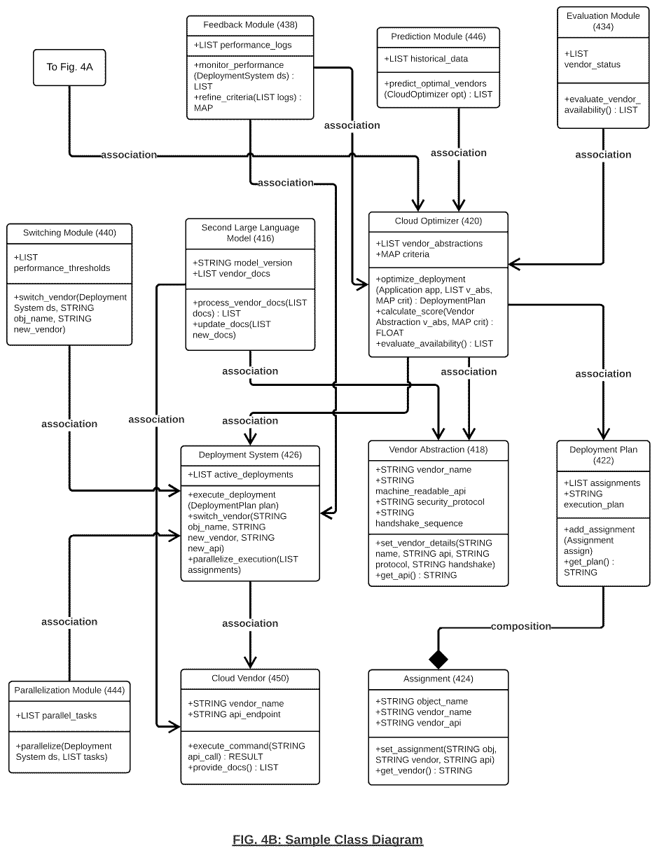

The FIG. 4A-4B class diagram commences with the Microservices Library (400), a foundational class that encapsulates the storage and management of a collection of microservices through its LIST<Microservice> microservices_collection attribute, which could be realized as an ArrayList in Java holding instances of microservices like a payment processor or data sorter. Its methods, such as add_microservice(Microservice ms), allow new microservices to be appended to this collection, potentially implemented as a method appending to a database table via JDBC, while get_microservice(STRING name) retrieves a specific microservice by name, possibly querying a MongoDB collection with a find operation, and update_from_external(STRING source) refreshes the library from external repositories, like a GitHub fetch operation coded in Python. This class serves as the central hub, interconnected with several others to facilitate microservice handling.

Closely tied to it is the Catalog (402), which maintains a LIST<Microservice> microservices attribute to mirror the library's contents, perhaps implemented as a synchronized list in C to ensure consistency. Its add_microservice(Microservice ms) method adds entries, potentially logging them to a file system, while get_microservice(STRING name) retrieves specifications, using a hash map lookup for efficiency, and generate_description_and_api( ) produces a LIST<STRING> of descriptions and API details, possibly generating JSON strings via a serialization library like Gson in Java. This class connects directly to the Microservices Library (400), forming a composition relationship with the Microservice (404) class, which defines individual microservices.

The Microservice (404) class includes attributes like STRING name for identification (e.g., “PaymentProcessor”), STRING functionality_description detailing its purpose (e.g., “Handles credit card transactions”), STRING api_specification outlining its interface (e.g., “/pay? amount=X”), and LIST<STRING> supported_vendors listing compatible platforms (e.g., [“AWS”, “Azure”]). Its set_attributes method initializes these fields, perhaps via a constructor in Python, while get_api() returns the API string, implemented as a simple getter. This class is a building block instantiated multiple times within both the Microservices Library (400) and Catalog (402), reflecting the modular nature of the system.

The First Large Language Model (406) class processes these specifications, with STRING model_version tracking its iteration (e.g., “v1.2”) and LIST<STRING> training_data holding inputs like UML diagrams, possibly stored as a vector in a machine learning framework like TensorFlow. Its process_catalog method transforms descriptions into LIST<Abstraction>, implemented by calling a pre-trained BERT model via a REST API, and train_model updates its capabilities, executed through a PyTorch training loop on a GPU cluster. This class associates with the Microservices Library (400) to receive data and produces instances of the Abstraction (408) class.

The Abstraction (408) class captures machine-readable representations with STRING microservice_name (e.g., “PaymentProcessor”), STRING machine_readable_api (e.g., a JSON API call), and LIST<STRING> supported_vendors, set via set_details and accessed with get_api, potentially coded as a lightweight struct in C++. It connects back to the First Large Language Model (406) as its output, feeding into the Generative Artificial Intelligence (410), which uses LIST<Abstraction> abstractions and STRING domain_objectives (e.g., “financial compliance”) to build applications. Its combine_microservices method creates an Application (412) instance, perhaps via a Java code generator, while generate_execution_plan and adapt_to_domain tailor the output, implemented with template engines and configuration parsing.

The Application (412) class holds LIST<Object> objects, a collection of executable units like a Java ArrayList, and STRING execution_plan (e.g., a YAML workflow), with methods like add_object appending new components and get_execution_plan retrieving the plan, coded as straightforward setters and getters. It contains multiple Object (414) instances, each with STRING name (e.g., “Sorter”) and STRING api_interface (e.g., “/sort”), where execute triggers the API call via an HTTP client like OkHttp, and set_interface configures it, ensuring modularity.

The Second Large Language Model (416) class, with STRING model_version and LIST<STRING> vendor_docs (e.g., AWS SDK docs), processes vendor data into LIST<VendorAbstraction> via process_vendor_docs, using a GPT-based model in a Flask app, and update_docs refreshes its inputs, perhaps via a cron job fetching updates. It connects to the Cloud Vendor (450) for documentation and produces Vendor Abstraction (418), which stores STRING vendor_name (e.g., “AWS”), STRING machine_readable_api, STRING security_protocol, and STRING handshake_sequence, set and accessed through simple methods, implemented as a data class in Python.

The Cloud Optimizer (420) class orchestrates deployment with LIST<VendorAbstraction> vendor_abstractions and MAP<STRING, FLOAT> criteria (e.g., {“cost”: 0.5, “efficiency”: 0.3}), using optimize_deployment to produce a DeploymentPlan (422), calculate_score for vendor evaluation via a weighted algorithm in Go, and evaluate_availability for real-time checks, possibly querying Prometheus. It connects to the Generative Artificial Intelligence (410) and Deployment System (426), managing the Deployment Plan (422) class, which holds LIST<Assignment> assignments and STRING execution_plan, with methods to build and retrieve the plan, coded as a structured object in C.

The Assignment (424) class details deployment specifics with STRING object_name, STRING vendor_name, and STRING vendor_api, set and accessed via basic methods, while the Deployment System (426) executes plans with LIST<Assignment> active_deployments, offering execute_deployment, switch_vendor, and parallelize_execution, implemented with Terraform scripts and a task queue like RabbitMQ. Supporting classes like Training Module (428) with STRING foundation_model and train_llm method, Adaptation Module (430) with adapt_gen_ai, and Update Module (432) with detect_and_update, all enhance core components, coded as modular services in a microservices architecture.

Additional classes like Evaluation Module (434) for availability checks, Planning Module (436) for execution plans, Feedback Module (438) for performance monitoring with refine_criteria, Switching Module (440) for vendor switches, Integration Module (442) for third-party integration, Parallelization Module (444) for concurrent execution, Prediction Module (446) for forecasting, Distribution Module (448) for decentralization, and Cloud Vendor (450) with execute_command and provide_docs, complete the diagram. Each class interconnects logically—e.g., Feedback Module (438) linking to Deployment System (426) and Cloud Optimizer (420)—forming a comprehensive, expandable structure for implementing the invention across diverse cloud environments like AWS, Azure, and Google Cloud, adaptable to domains like finance or logistics.

Pseudocode exemplars for implementing various aspects of this disclosure are set forth below with explanations for reference.
//Define Microservices Library and Catalog Structures
DEFINE STRUCTURE Microservice
   STRING name
   STRING functionality_description
   STRING api_specification
   LIST<STRING> supported_vendors
END STRUCTURE
DEFINE STRUCTURE Catalog
   LIST<Microservice> microservices
   FUNCTION add_microservice(Microservice ms)
      APPEND ms TO microservices
   END FUNCTION
   FUNCTION get_microservice(STRING name) RETURNS Microservice
      FOR EACH ms IN microservices
         IF ms.name EQUALS name THEN RETURN ms
      END FOR
      RETURN NULL
   END FUNCTION
END STRUCTURE
INITIALIZE Catalog microservice_catalog
//LLM1: Generate Machine-Understandable Microservice Abstractions
FUNCTION generate_microservice_abstraction(Catalog catalog) RETURNS LIST<Abstraction>
   LIST<Abstraction> abstractions
   FOR EACH ms IN catalog.microservices
      STRING description=ms.functionality_description
      STRING api_spec=ms.api_specification
      Abstraction abs=LLM1_PROCESS(description, api_spec)
      APPEND abs TO abstractions
   END FOR
   RETURN abstractions
END FUNCTION
DEFINE STRUCTURE Abstraction
   STRING microservice_name
   STRING machine_readable_api
   LIST<STRING> supported_vendors
END STRUCTURE
//Gen AI1: Combine Microservices into Object-Oriented Application
FUNCTION combine_microservices(LIST<Abstraction> abstractions, STRING app_objectives) RETURNS Application
   Application app
   LIST<Object> objects
   FOR EACH abs IN abstractions
      Object obj=CREATE_OBJECT(abs. microservice_name, abs. machine_readable_api)
      APPEND obj TO objects
   END FOR
   app =GEN_AI1_PROCESS(objects, app_objectives)
   RETURN app
END FUNCTION
DEFINE STRUCTURE Object
   STRING name
   STRING api_interface
   FUNCTION execute() RETURNS RESULT
      RETURN CALL_API(api_interface)
   END FUNCTION
END STRUCTURE
DEFINE STRUCTURE Application
   LIST<Object> objects
   STRING execution_plan
END STRUCTURE
//LLM2: Generate Vendor-Specific API Abstractions
FUNCTION generate_vendor_api_abstraction(LIST<STRING> vendor_docs) RETURNS
LIST<VendorAbstraction>
   LIST<VendorAbstraction> vendor_abstractions
   FOR EACH doc IN vendor_docs
      VendorAbstraction v_abs=LLM2_PROCESS(doc)
      APPEND v_abs TO vendor_abstractions
   END FOR
   RETURN vendor_abstractions
END FUNCTION
DEFINE STRUCTURE VendorAbstraction
   STRING vendor_name
   STRING machine_readable_api
   STRING security_protocol
   STRING handshake_sequence
END STRUCTURE
//Cloud Optimizer: Select Optimal Vendor for Microservices
FUNCTION optimize_cloud_deployment(Application app, LIST<VendorAbstraction> vendor_abs, MAP<STRING, FLOAT>criteria) RETURNS DeploymentPlan
   DeploymentPlan plan
   LIST<Assignment> assignments
   FOR EACH obj IN app.objects
      STRING best_vendor=“”
      FLOAT best_score=-INFINITY
      FOR EACH v_abs IN vendor_abs
         IF obj. api_interface COMPATIBLE_WITH v_abs. machine_readable_api THEN
         FLOAT score=CALCULATE_SCORE(v_abs, criteria)
         IF score>best_score THEN
         best_score=score
         best_vendor=v_abs.vendor_name
         END IF
         END IF
      END FOR
         Assignment assign=CREATE_ASSIGNMENT(obj.name, best_vendor, v_abs.machine_readable_api)
      APPEND assign TO assignments
   END FOR
   plan.assignments=assignments
   plan.execution_plan=GENERATE_EXECUTION_PLAN(assignments)
   RETURN plan
END FUNCTION
DEFINE STRUCTURE Assignment
   STRING object_name
   STRING vendor_name
   STRING vendor_api
END STRUCTURE
DEFINE STRUCTURE DeploymentPlan
   LIST<Assignment> assignments
   STRING execution_plan
END STRUCTURE
FUNCTION CALCULATE_SCORE(VendorAbstraction v_abs, MAP<STRING, FLOAT> criteria) RETURNS FLOAT
   FLOAT score=0
   FOR EACH key, value IN criteria
      IF key EQUALS “cost” THEN score+=EVALUATE_COST(v_abs)*value
      IF key EQUALS “efficiency” THEN score+=EVALUATE_EFFICIENCY(v_abs)*value
         IF key EQUALS “availability” THEN score+=EVALUATE_AVAILABILITY(v_abs)*value
      END FOR
   RETURN score
END FUNCTION
//Main Execution Workflow
FUNCTION main(STRING app_objectives, LIST<STRING> vendor_docs, MAP<STRING, FLOAT> optimization_criteria)
   LIST<Abstraction> microservice_abs=generate_microservice_abstraction(microservice_catalog)
   Application app=combine_microservices(microservice_abs, app_objectives)
      LIST<VendorAbstraction> vendor_abs=generate_vendor_api_abstraction(vendor_docs)
      DeploymentPlan plan=optimize_cloud_deployment(app, vendor_abs, optimization_criteria)
   EXECUTE_DEPLOYMENT(plan)
END FUNCTION
FUNCTION EXECUTE_DEPLOYMENT(DeploymentPlan plan)
   FOR EACH assign IN plan.assignments
      Object obj=FIND_OBJECT(assign.object_name)
      CONFIGURE(obj, assign.vendor_api)
      RESULT res=obj.execute()
      LOG_RESULT(res)
   END FOR
END FUNCTION

The pseudocode begins by defining foundational data structures to manage the microservices library and its associated catalog. A Microservice structure encapsulates details such as a name, a description of its functionality, its API specification, and a list of supported vendors, providing a comprehensive representation of each modular component. The Catalog structure maintains a list of these microservices and includes functions to add new microservices and retrieve existing ones by name, enabling efficient storage and access. An instance of the Catalog, named microservice_catalog, is initialized to serve as the central repository, ensuring that all microservices are organized and accessible for subsequent processing.

The next segment introduces the functionality of LLM1, which automates the abstraction of microservices from the catalog. The generate_microservice_abstraction function iterates through each microservice in the catalog, extracting its functionality description and API specification. It then invokes a hypothetical LLM1_PROCESS function, representing the large language model's capability to interpret these details and produce a machine-readable abstraction. Each abstraction, stored in an Abstraction structure, includes the microservice's name, a machine-readable API, and supported vendors, creating a standardized, computer-friendly representation that eliminates manual interpretation and prepares the microservices for integration.

Following this, the pseudocode outlines the process of combining microservices into a complete application using Gen AI1. The combine_microservices function takes the list of abstractions and a string defining the application's objectives as inputs. It creates an Object for each abstraction, where each Object contains a name and an API interface, along with an execute function to invoke the microservice's functionality via its API. These objects are then processed by a GEN_AI1_PROCESS function, which represents the generative AI's role in stitching them together into an Application structure. This structure includes a list of objects and an execution plan, resulting in object-oriented code that aligns with the specified objectives, leveraging the modularity of microservices.

The pseudocode then addresses the adaptation of microservices to specific cloud vendors through LLM2. The generate_vendor_api_abstraction function processes a list of vendor documentation, invoking an LLM2_PROCESS function to interpret each document. This produces a VendorAbstraction structure for each vendor, containing the vendor's name, a machine-readable API, security protocol, and handshake sequence. These abstractions encapsulate the unique requirements of each vendor, enabling the system to deploy microservices across diverse platforms by providing the necessary interface details in a format that machines can utilize directly.

A core component of the invention, the cloud optimizer, is implemented in the optimize_cloud_deployment function. This function takes an application, a list of vendor abstractions, and a map of optimization criteria (such as cost, efficiency, and availability) as inputs. It iterates through each object in the application, evaluating compatible vendors from the vendor abstractions. For each compatible vendor, it calculates a score using the CALCULATE_SCORE function, which weighs criteria like cost and efficiency based on provided values. The vendor with the highest score is selected, and an Assignment structure is created to pair the object with the chosen vendor and its API. These assignments are compiled into a DeploymentPlan, which includes an execution plan generated from the assignments, ensuring optimal deployment across vendors.

The CALCULATE_SCORE function provides the logic for the optimizer's decision-making process. It evaluates a vendor abstraction against the optimization criteria, assigning scores based on factors such as cost, efficiency, and availability through hypothetical evaluation functions (EVALUATE_COST, EVALUATE_EFFICIENCY, EVALUATE_AVAILABILITY). Each criterion's impact is weighted by the corresponding value in the criteria map, producing a composite score that reflects the vendor's suitability. This scoring mechanism allows the optimizer to dynamically select vendors based on real-time conditions, balancing multiple factors to achieve the best deployment outcome.

The main execution workflow is encapsulated in the main function, which orchestrates the entire process. It starts by generating microservice abstractions using LLM1, then combines them into an application with Gen AI1 based on the provided objectives. Next, it generates vendor-specific API abstractions with LLM2 using vendor documentation. The resulting application and vendor abstractions are passed to the cloud optimizer, which produces a deployment plan tailored to the specified optimization criteria. Finally, the plan is executed by the EXECUTE_DEPLOYMENT function, integrating all components into a cohesive operation.

The EXECUTE_DEPLOYMENT function executes the deployment plan by iterating through each assignment. It locates the corresponding object by name, configures it with the vendor-specific API from the assignment, and invokes its execute function to run the microservice. The results are logged, simulating the deployment and operation of the application across the selected vendors. This function ensures that the system's automated decisions are translated into actionable steps, completing the end-to-end workflow from abstraction to execution.

The pseudocode's design reflects the invention's emphasis on automation and modularity. By defining structures like Microservice, Abstraction, Object, VendorAbstraction, Assignment, and DeploymentPlan, it provides a clear framework for managing complex data and interactions. Functions like generate_microservice_abstraction and generate_vendor_api_abstraction leverage large language models to eliminate manual effort, while combine_microservices and optimize_cloud_deployment use generative AI and optimization logic to assemble and deploy applications efficiently.

The use of object-oriented principles is evident in the Object and Application structures, where microservices are mapped to objects with defined interfaces, facilitating integration and maintenance. The cloud optimizer's flexibility, supported by the CALCULATE_SCORE function, allows for rule-based or statistical approaches to vendor selection, adapting to different operational needs. The pseudocode captures the invention's ability to switch vendors dynamically, as the deployment plan can reassign microservices based on the optimizer's decisions, supported by LLM2's vendor-specific abstractions.

Overall, the pseudocode provides a sample blueprint for implementing various aspects of the invention's features, including the microservices library, catalog automation, application assembly, vendor adaptation, and dynamic optimization. It ensures that each aspect is represented with sufficient specificity to guide development, while remaining abstract enough to allow for implementation in various programming languages and environments. The integration of artificial intelligence and structured data management underscores the system's innovative approach to managing software across multiple cloud vendors.

The systems and methods described in the disclosure offer a robust framework for managing software applications across multiple cloud vendors using a microservices-based, object-oriented approach, and several alternatives, modifications, combinations, and customizations can be implemented within the spirit and scope of this technology. One potential modification involves altering the structure of the microservices library to include additional metadata, such as version numbers, dependency information, or performance metrics, which could enhance the system's ability to select and manage microservices. This adjustment would allow the catalog to provide more granular details, enabling more precise automation by the first large language model when generating abstractions, without departing from the core concept of a centralized repository of modular components.

Another alternative could involve replacing the large language models with other artificial intelligence techniques, such as rule-based systems or supervised machine learning algorithms, to interpret the catalog and vendor documentation. For instance, a rule-based system might rely on predefined templates to map functionality descriptions to machine-readable formats, offering a simpler implementation where computational resources are limited. This substitution maintains the goal of automating abstraction processes, adapting the method to different technical environments while preserving the system's intent to eliminate manual intervention.

The generative artificial intelligence component responsible for combining microservices into applications could be customized to support alternative programming paradigms beyond object-oriented code. For example, a functional programming approach could be adopted, where microservices are composed as pure functions with immutable state, potentially improving concurrency and scalability in certain contexts. This modification aligns with the disclosure's emphasis on modularity and flexibility, allowing the system to cater to diverse software development preferences while achieving the same outcome of assembling applications from reusable components.

The cloud optimizer's decision-making process presents opportunities for significant customization. Instead of relying solely on a weighted scoring system based on cost, efficiency, and availability, the optimizer could incorporate additional criteria, such as latency, energy consumption, or vendor reliability, depending on the specific needs of the deployment environment. Furthermore, the optimization logic could be extended to use reinforcement learning, where the system learns optimal vendor selections over time through trial and error, enhancing its adaptability to dynamic conditions while remaining true to the disclosure's focus on dynamic resource allocation.

A combination of these elements could involve integrating the modified microservices library with a customized optimizer. For instance, performance metrics from the library could feed directly into a reinforcement learning-based optimizer, allowing it to make decisions informed by historical execution data rather than static criteria alone. This hybrid approach would enhance the system's ability to adapt to real-time performance trends, combining the strengths of detailed component tracking and advanced optimization within the same overarching framework of multi-vendor management.

The method of generating vendor-specific API abstractions could be altered by employing a hybrid model that combines large language models with manual configuration files for critical vendors. In scenarios where vendor documentation is incomplete or ambiguous, predefined templates could supplement the automated abstraction process, ensuring compatibility without relying entirely on AI interpretation. This customization maintains the disclosure's aim of seamless vendor integration, offering a practical compromise for environments with inconsistent documentation standards.

Another modification could involve decentralizing the microservices library and catalog across multiple nodes rather than maintaining a single centralized repository. In a distributed setup, each node could host a subset of microservices, synchronized through a consensus mechanism, improving fault tolerance and reducing latency in large-scale deployments. This alternative aligns with the spirit of scalability and resilience inherent in the disclosure, adapting the architecture to distributed computing paradigms while retaining the core functionality of microservice management.

The execution plan generated for applications could be customized to include parallel processing capabilities, where microservices within an application are executed concurrently across different vendors when feasible. This adjustment would leverage the modularity of microservices to enhance performance, particularly for applications with independent components, staying within the scope of efficient deployment across multiple platforms as envisioned by the disclosure.

A further combination might integrate the decentralized library with parallel execution, allowing the system to dynamically distribute microservices across nodes and vendors simultaneously. For example, a sorting microservice could run on one vendor while a data retrieval microservice operates on another, coordinated through a distributed catalog and executed in parallel. This approach combines scalability, performance, and multi-vendor utilization, reflecting the disclosure's intent to optimize resource use across diverse environments.

The system could also be modified to support real-time updates to the microservices library and catalog, where new microservices or updated vendor protocols are incorporated on-the-fly without interrupting ongoing operations. This would involve adding a monitoring component that detects changes in vendor specifications or application requirements, triggering updates to the abstractions and deployment plans accordingly. Such a customization enhances the system's responsiveness, a key aspect of its design, ensuring it remains effective in rapidly changing conditions.

Another alternative could involve extending the system to support hybrid cloud environments, combining public cloud vendors with private on-premises infrastructure. The cloud optimizer could be adjusted to evaluate on-premises resources alongside external vendors, factoring in data locality or security constraints. This modification broadens the applicability of the disclosure, maintaining its focus on flexible deployment while accommodating a wider range of operational setups.

The use of foundation models could be customized by training them on domain-specific datasets, such as financial transaction processing or supply chain logistics, rather than general-purpose code generation. This specialization would improve the accuracy of microservice abstractions and application assembly for particular industries, aligning with the disclosure's goal of tailoring software solutions to specific needs without altering its fundamental structure.

A combination of hybrid cloud support and domain-specific training could create a system optimized for sensitive applications, where certain microservices run on private infrastructure for security, while others leverage public vendors for scalability, all assembled using industry-tailored AI models. This hybrid customization exemplifies the disclosure's adaptability, merging multiple enhancements into a cohesive solution.

The optimizer could also be modified to operate in a predictive mode, using historical data and forecasting models to preemptively adjust deployments before conditions change. For instance, it might anticipate peak loads and shift microservices to more capable vendors in advance, enhancing proactive management within the scope of dynamic optimization outlined in the disclosure.

Another modification might involve adding a feedback loop where execution results from deployed microservices inform updates to the catalog and optimizer criteria. If a microservice performs poorly on a specific vendor, this data could refine future abstractions and scoring, creating a self-improving system that aligns with the disclosure's emphasis on efficiency and adaptability.

The system could be customized to support multi-tenancy, where multiple organizations share the same microservices library and catalog, with access controls to segregate proprietary data. This would extend the invention's utility to collaborative environments, maintaining its core functionality while broadening its deployment context.

A combination of predictive optimization and multi-tenancy could enable a shared platform that anticipates the needs of multiple users, dynamically allocating resources across vendors to balance collective demand. This integration stays within the spirit of resource optimization and scalability central to the disclosure.

The execution workflow could be altered to include rollback mechanisms, where failed deployments trigger automatic reversion to a previous plan, ensuring reliability. This enhancement complements the disclosure's focus on seamless operation, adding a layer of fault tolerance without changing its fundamental approach.

Another alternative might involve integrating third-party microservices from external providers into the library, expanding the range of available components. The system would adapt these external services through the same abstraction and optimization processes, preserving the disclosure's modular design while enhancing its ecosystem.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. These alternatives, modifications, combinations, and customizations demonstrate the flexibility of the disclosed systems and methods, ensuring they can be tailored to diverse technical requirements while remaining true to the underlying principles of modularity, automation, and multi-vendor optimization.

1. A method for managing software applications across multiple cloud vendors, the method comprising:
creating, by a microservices library, a collection of microservices, each microservice configured to perform a specific function;
generating, by a catalog, a description of functionality and an application programming interface (API) specification for each microservice in the collection;
processing, by a first large language model, the description of functionality and the API specification from the catalog to produce a machine-readable abstraction for each microservice;
combining, by a generative artificial intelligence, the machine-readable abstractions into an application structured as object-oriented code, wherein each microservice corresponds to an object with a defined interface;
analyzing, by a second large language model, documentation from a plurality of cloud vendors to generate a vendor-specific machine-readable API abstraction for each cloud vendor;
optimizing, by a cloud optimizer, deployment of the application by selecting a cloud vendor from the plurality of cloud vendors for each microservice based on predefined criteria including cost and efficiency; and
executing, by a deployment system, the application across the selected cloud vendors using the vendor-specific machine-readable API abstractions.

2. The method of claim 1, further comprising training, by a training module, the first large language model using a foundation model adapted with computer-executable source code and architectural descriptions to enhance interpretation of the catalog.

3. The method of claim 2, further comprising adapting, by an adaptation module, the generative artificial intelligence to incorporate domain-specific objectives into the object-oriented code based on requirements of the application.

4. The method of claim 3, further comprising updating, by an update module, the microservices library in real-time with new microservices detected from external sources to expand the collection.

5. The method of claim 4, further comprising evaluating, by the cloud optimizer, vendor availability as an additional criterion to dynamically adjust the selection of cloud vendors during execution.

6. The method of claim 5, further comprising generating, by the generative artificial intelligence, an execution plan specifying a sequence of operations for the objects within the application.

7. The method of claim 6, further comprising monitoring, by a feedback module, performance results of the executed application to refine the predefined criteria used by the cloud optimizer.

8. The method of claim 7, further comprising switching, by the deployment system, a microservice from a first cloud vendor to a second cloud vendor using a corresponding vendor-specific machine-readable API abstraction when the first cloud vendor fails to meet performance thresholds.

9. The method of claim 8, further comprising integrating, by the microservices library, third-party microservices into the collection by processing their specifications through the first large language model.

10. The method of claim 9, further comprising parallelizing, by the deployment system, execution of independent microservices across different cloud vendors to enhance application performance.

11. A method for managing software applications across multiple cloud vendors, the method comprising:
creating, by a microservices library, a collection of microservices, each microservice configured to perform a specific function;
generating, by a catalog, a description of functionality and an application programming interface (API) specification for each microservice in the collection;
processing, by a first large language model, the description of functionality and the API specification from the catalog to produce a machine-readable abstraction for each microservice;
combining, by a generative artificial intelligence, the machine-readable abstractions into an application structured as object-oriented code, wherein each microservice corresponds to an object with a defined interface;
analyzing, by a second large language model, documentation from a plurality of cloud vendors to generate a vendor-specific machine-readable API abstraction for each cloud vendor;
optimizing, by a cloud optimizer, deployment of the application by selecting a cloud vendor from the plurality of cloud vendors for each microservice based on predefined criteria including cost and efficiency;
executing, by a deployment system, the application across the selected cloud vendors using the vendor-specific machine-readable API abstractions;
training, by a training module, the first large language model using a foundation model adapted with computer-executable source code and architectural descriptions to enhance interpretation of the catalog;
adapting, by an adaptation module, the generative artificial intelligence to incorporate domain-specific objectives into the object-oriented code based on requirements of the application;
updating, by an update module, the microservices library in real-time with new microservices detected from external sources to expand the collection;
evaluating, by the cloud optimizer, vendor availability as an additional criterion to dynamically adjust the selection of cloud vendors during execution;
generating, by the generative artificial intelligence, an execution plan specifying a sequence of operations for the objects within the application;
monitoring, by a feedback module, performance results of the executed application to refine the predefined criteria used by the cloud optimizer;
switching, by the deployment system, a microservice from a first cloud vendor to a second cloud vendor using a corresponding vendor-specific machine-readable API abstraction when the first cloud vendor fails to meet performance thresholds;
integrating, by the microservices library, third-party microservices into the collection by processing their specifications through the first large language model;
parallelizing, by the deployment system, execution of independent microservices across different cloud vendors to enhance application performance;
configuring, by a configuration module, the cloud optimizer to operate in a predictive mode using historical data to preemptively adjust vendor selections; and
distributing, by a distribution module, the microservices library across multiple nodes to enable decentralized management of the collection.

12. A system for managing software applications across multiple cloud vendors comprising:
a microservices library configured to store a collection of microservices, each microservice performing a specific function;
a catalog coupled to the microservices library configured to generate a description of functionality and an application programming interface (API) specification for each microservice;
a first large language model coupled to the catalog configured to process the description of functionality and the API specification to produce a machine-readable abstraction for each microservice;
a generative artificial intelligence coupled to the first large language model configured to combine the machine-readable abstractions into an application structured as object-oriented code, wherein each microservice corresponds to an object with a defined interface;
a second large language model configured to analyze documentation from a plurality of cloud vendors to generate a vendor-specific machine-readable API abstraction for each cloud vendor;
cloud optimizer coupled to the generative artificial intelligence and the second large language model configured to select a cloud vendor from the plurality of cloud vendors for each microservice based on predefined criteria including cost and efficiency; and
a deployment system coupled to the cloud optimizer configured to execute the application across the selected cloud vendors using the vendor-specific machine-readable API abstractions.

13. The system of claim 12, further comprising a training module coupled to the first large language model configured to train the first large language model using a foundation model adapted with computer-executable source code and architectural descriptions to enhance interpretation of the catalog.

14. The system of claim 13, further comprising an adaptation module coupled to the generative artificial intelligence configured to adapt the generative artificial intelligence to incorporate domain-specific objectives into the object-oriented code based on requirements of the application.

15. The system of claim 14, further comprising an update module coupled to the microservices library configured to update the microservices library in real-time with new microservices detected from external sources to expand the collection.

16. The system of claim 15, further comprising an evaluation module integrated into the cloud optimizer configured to evaluate vendor availability as an additional criterion to dynamically adjust the selection of cloud vendors during execution.

17. The system of claim 16, further comprising a planning module integrated into the generative artificial intelligence configured to generate an execution plan specifying a sequence of operations for the objects within the application.

18. The system of claim 17, further comprising a feedback module coupled to the deployment system and the cloud optimizer configured to monitor performance results of the executed application to refine the predefined criteria.

19. The system of claim 18, further comprising a switching module integrated into the deployment system configured to switch a microservice from a first cloud vendor to a second cloud vendor using a corresponding vendor-specific machine-readable API abstraction when the first cloud vendor fails to meet performance thresholds.

20. The system of claim 19, further comprising:
an integration module coupled to the microservices library and the first large language model configured to integrate third-party microservices into the collection by processing their specifications through the first large language model;
a parallelization module integrated into the deployment system configured to parallelize execution of independent microservices across different cloud vendors to enhance application performance;
a prediction module integrated into the cloud optimizer configured to operate in a predictive mode using historical data to preemptively adjust vendor selections based on anticipated conditions; and
a distribution module coupled to the microservices library configured to distribute the microservices library across multiple nodes to enable decentralized management of the collection, wherein the distribution module synchronizes the nodes to maintain consistency of the microservices across the system.
